(19) United States
(12) Patent Application Publication
(10) Pub. No.: US 2013/0053233 A1
(43) Pub. Date: Feb. 28, 2013

(54) METHOD FOR PRODUCING A SHEET OF GLASS

(71) Applicants: Olivier Mario, Paris (FR); Edouard Brunet, Paris (FR); Octavio Cintora, Taverny (FR)

(72) Inventors: Olivier Mario, Paris (FR); Edouard Brunet, Paris (FR); Octavio Cintora, Taverny (FR)

(73) Assignee: SAINT-GOBAIN GLASS FRANCE, Courbevoie (FR)

(21) Appl. No.: 13/501,433

(22) PCT Filed: Oct. 11, 2010
(86) PCT No.: PCT/FR10/52145

§ 371 Date: Apr. 30, 2012

(30) Foreign Application Priority Data
Oct. 12, 2009 (FR) 0957113

(51) Int. Cl. C03B 13/00; C03C 3/00

(52) U.S. Cl. 501/11; 65/90

(57) ABSTRACT

A process for obtaining a glass sheet including antimony oxide, the process including a step of melting a batch mix, a step of transporting the molten glass to at least one forming device, and a forming step, in which glass frit including a weight content of antimony oxide between 2 and 30% is added, concurrently or alternately, to the batch mix, during the melting step, or during the step of transporting the molten glass to at least one forming device.

The invention relates to the field of glass frits. More specifically, the invention relates to glass frits that can be used for producing glass sheets.

The glass sheets are of use in numerous applications: glazing for buildings or motor vehicles, energy production, especially photovoltaic systems or mirrors for concentrating solar energy, display screens, etc.

In applications for the production of energy, glasses having high light transmission and energy transmission, often referred to as “extra-clear” or “ultra-clear” glasses, are used. These glasses contain small amounts of iron oxide, and in particular small amounts of ferrous iron (Fe²⁺) since the latter is particularly absorbent in the visible and near infrared spectra, therefore in the range of maximum efficiency of photo-voltaic cells. In order to maximize the light and energy transmission, it is customary to add a chemical oxidizing agent to the glass in order to oxidize the ferrous iron and therefore to reduce the content of the latter as much as possible. Very low redox values, especially zero or almost zero, may thus be obtained. The term redox is understood to mean the ratio between the weight content of ferrous iron oxide, expressed in the form FeO, and the weight content of total iron oxide, expressed in the form Fe₂O₃.

Antimony oxide, described for example in application FR 2 317 242, is among the oxidizing agents that have been commonly used for many years. Antimony is added to the batch mix by means of antimony pentoxide (Sb₂O₅), sodium antimonate, or else antimony trioxide (Sb₂O₃), in the latter case generally in combination with a nitrate such as sodium nitrate.

The addition of antimony to the batch mix is not however without drawbacks in terms of production of the glass. In particular, the high transmission of infrared radiation by the molten oxidized glass has the effect of facilitating heat transfer via radiation from the burners to the floor of the furnace. Taking into account the great height of glass in industrial furnaces, small differences in terms of redox have very significant consequences on the transmission of radiation. The temperatures observed at the floor are then greatly increased, which damages the service life of the furnace. Moreover, antimony oxide is incompatible with certain glass forming processes, including the float process, in which the molten glass is poured onto a liquid metal, generally tin. For this reason, the use of antimony oxide via addition of antimony to the batch mix is not possible in the case of a single furnace connected to several forming devices, at least one of which is a float device. Finally, the storage and handling of antimony oxide must be the subject of strict control in terms of the environment and occupational hygiene and safety.

The objective of the invention is to overcome at least one of these drawbacks.

For this purpose, one subject of the invention is a process for obtaining a glass sheet comprising antimony oxide, said process comprising a step of melting a batch mix, a step of transporting the molten glass to at least one forming device, and a forming step, in which glass frit comprising a weight content of antimony oxide between 2 and 30%, in particular between 2 and 20%, is added, concurrently or alternately, to said batch mix, during said melting step, or during said step of transporting the molten glass to at least one forming device.

Another subject of the invention is a glass frit comprising a weight content of antimony oxide of between 2 and 30%, in particular between 2 and 20%.

The fact of incorporating antimony oxide into a glass frit makes it possible to facilitate the handling thereof. Moreover, the addition of the frit after the melting step makes it possible to avoid reducing the service life of the furnace following excessive heating of the floor. Indeed, it is possible to melt, in the furnace, a glass of normal redox, in particular between 0.4 and 0.5 in the case of glasses having a low iron content, and therefore that has a lower transmission. After melting, and during the transport between the melting furnace and the forming device, in a channel or a “feeder”, the glass frit according to the invention may be added. Surprisingly, such an addition makes it possible to very strongly oxidize the glass to greater levels than when the antimony is added to the batch mix, and this without in any way degrading the quality of the glass in terms of refining and homogeneity.

The glass frit according to the invention or that is used in the process according to the invention (therefore before addition) preferably has one or more of the following preferred features, in any possible combination:
the weight content of antimony oxide is preferably between 8 and 15%; a content of around 10% makes it possible to obtain a weight content of 0.2 to 0.3% with dilution rates that are perfectly feasible on an industrial scale;
the proportion of pentavalent antimony (Sb⁵⁺) relative to all of the antimony is preferably greater than or equal to 20%. This proportion may be determined by Mössbauer spectroscopy. The large amount of pentavalent antimony makes it possible to oxidize the ferrous iron more effectively during the addition of the frit to the molten glass. An oxidized frit, close to the final oxidation state of the glass, moreover makes it possible to avoid the risks of reboiling linked to the presence of sulfate in the glass or due to the release of oxygen during an excessive reduction of the antimony;
the temperature at which the viscosity of the glass is 100 poise (1 poise=0.1 Pa.$) is preferably between 850 and 1150° C.;
the viscosity at a temperature of 1050° C. is between 30 and 300 poise; the latter two preferred features make it possible to facilitate the melting of the frit when it is added to the molten glass, generally at a temperature between 1000 and 1150° C., and to facilitate the mixing between the molten frit and the molten glass;
the frit preferably comprises the following constituents in contents varying within the weight limits defined below:

| | |
|---|---|
| SiO₂ | 45 to 65% |
| Al₂O₃ | 0 to 10% |
| B₂O₃ | 0 to 5%, preferably 0 |
| CaO | 5 to 20% |
| MgO | 0 to 10% |
| Na₂O | 5 to 20% |
| K₂O | 0 to 10% |
| BaO | 0 to 5%, preferably 0 |
| Li₂O | 0 to 5% |
| Sb₂O₃ | 5 to 30%; |

the composition of the frit is advantageously free of boron, arsenic, oxides of transition elements such as CoO, CuO, Cr₂O₃ and MnO₂, oxides of rare earths such as CeO₂, La₂O₃ and Nd₂O₃, or else coloring agents in the elemental state such as Se, Ag, Cu and Au;
the glass frit is advantageously in the form of fragments, the maximum dimension of which does not exceed 10 mm, or even 2 mm, so as to facilitate the fusion thereof and the digestion thereof by the glass bath; however this maximum dimension is preferably greater than or equal to 0.1 mm so as not to introduce gas, in particular air, into the molten glass.

Another subject of the invention is the process for obtaining frits according to the invention. The frits are preferably obtained by melting a pulverulent batch mix. The melting may be continuous (for example in a tank furnace) or in batch mode (for example in a pot furnace). The energy necessary to obtain the molten frit may be provided by flames (for example by means of overhead or submerged burners) or by electricity (for example by means of electrodes, especially made of molybdenum, submerged in the molten glass bath).

The raw materials are typically chosen from silica sand, feldspar, nepheline syenite, sodium carbonate, potassium carbonate, limestone and dolomite. The antimony carrier is preferably pentavalent antimony oxide (Sb₂O₅), rather than trivalent antimony oxide (Sb₂O₃) so as to obtain a frit that is as rich as possible in pentavalent antimony. For the same reason, the melting temperature preferably does not exceed 1400° C., in particular 1350° C. or 1300° C., since it has been observed that the lowest temperatures made it possible to retain a more oxidized frit. For the same purpose, it is possible to incorporate an oxidizing agent such as sulfates or nitrates, for example sodium sulfate or sodium nitrate, into the batch mix.

The forming of the frit may especially be carried out by rolling then crushing and milling in order to obtain flakes.

In the process for obtaining a glass sheet according to the invention, the glass frit is preferably only added during the step of transporting the molten glass to at least one forming device. Indeed, it is in this embodiment that the invention provides the most advantages. The addition is preferably carried out when the temperature of the molten glass is between 1200 and 1350° C., in particular between 1200 and 1300° C.

The forming is preferably carried out by rolling between several rolls. At least one of the casting rolls is preferably textured so as to form reliefs on at least one of the faces of the glass sheet. As explained in greater detail in the remainder of the text, certain reliefs make it possible to trap light and to increase the amount of energy on photovoltaic cells. Other forming processes are possible, such as for example the Fourcault drawing process or a down-draw type process.

The glass sheet preferably has a composition of soda-lime-silica type, for reasons of ease of melting and processing. However, other types of glasses may be used, in particular glasses of borosilicate, alumino-silicate or aluminoborosilicate type.

The expression “composition of soda-lime-silica type” is understood to mean a composition comprising silica (SiO₂) as a forming oxide and sodium oxide (soda Na₂O) and calcium oxide (lime CaO). This composition preferably comprises the following constituents in contents that vary within the weight limits defined below:

| | |
|---|---|
| SiO₂ | 60-75% |
| Al₂O₃ | 0-10% |
| B₂O₃ | 0-5%, preferably 0 |
| CaO | 5-15% |
| MgO | 0-10% |
| Na₂O | 5-20% |
| K₂O | 0-10% |
| BaO | 0-5%, preferably 0 |

The glass sheet obtained according to the invention is preferably such that its light transmission within the meaning of the ISO 9050: 2003 standard is greater than or equal to 90%, in particular 90.5%, or even 91%, for a thickness of 3.2 mm.

The glass sheet obtained according to the invention is preferably such that its energy transmission (T_{E}) calculated according to the ISO 9050: 2003 standard is greater than or equal to 90%, in particular 90.5%, or even 91% and even 91.5%, for a thickness of 3.2 mm.

The chemical composition of the glass sheet obtained according to the invention preferably comprises iron oxide, in a weight content, expressed as Fe₂O₃, between 0.003% and 0.05%, in particular between 0.007% and 0.02%, or less than or equal to 0.015%. Such contents make it possible to achieve high light transmissions. Contents lower than 0.005% are however difficult to obtain since they imply a very thorough, and therefore expensive, purification of the raw materials.

Owing to the addition of antimony oxide, the redox obtained is generally less than or equal to 0.1, preferably less than or equal to 0.05, or even zero.

The glass sheet obtained according to the invention is preferably flat or curved. It is advantageously curved in a cylindro-parabolic shape when it is intended to be used for manufacturing parabolic mirrors for concentrating solar energy. The glass sheet according to the invention may be of any size, generally between 0.5 and 6 meters. Its thickness is generally between 1 and 10 mm, in particular between 2 and 6 mm.

The glass sheet obtained according to the invention preferably does not comprise any agent that absorbs visible or infrared radiation (especially for a wavelength between 380 and 1000 nm) other than those already cited. In particular, the composition according to the invention preferably does not contain agents chosen from the following agents, or contains none of the following agents: oxides of transition elements such as CoO, CuO, Cr₂O₃ and MnO₂, oxides of rare earths such as CeO₂, La₂O₃ and Nd₂O₃, or else coloring agents in the elemental state such as Se, Ag, Cu and Au. These agents very often have a very powerful undesirable coloring effect which appears at very low contents, sometimes of the order of a few ppm or less (1 ppm=0.0001%). Their presence thus very greatly reduces the transmission of the glass.

The melting may be carried out in continuous furnaces, heated with the aid of electrodes and/or with the aid of burners, which are overhead and/or submerged and/or positioned in the roof of the furnace so that the flame impacts the raw materials or the glass bath. The raw materials are generally pulverulent and comprise natural materials (sand, feldspars, limestone, dolomite, nepheline syenite, etc.) or synthetic materials (sodium carbonate or potassium carbonate, boric anhydride, sodium sulfate, etc.). The raw materials are loaded into the furnace then undergo melting reactions in the physical sense of the term and various chemical reactions that lead to a glass bath being obtained. The molten glass is then conveyed to a forming step during which the glass sheet will adopt its shape.

The glass sheet obtained according to the invention may be coated on at least one of its faces with at least one thin layer or at least one multilayer providing at least one additional functionality: anti-reflection layer or conversely reflective layer (for example silvering layer for mirrors), conductive layer (based for example on fluorine-doped or antimony-doped tin oxide, or on aluminum-doped or gallium-doped zinc oxide, or on a mixed indium tin oxide), low-emissivity or solar-protection layer (based for example on silver, generally protected by other layers), anti-soiling or self-cleaning layer (based for example on titanium oxide, especially crystallized in anatase form). If the glass sheet is intended to be used in mirrors, especially mirrors for concentrating solar energy, the sheet is coated with a layer of silver, which is protected against oxidation by at least one layer of paint.

The glass sheet obtained according to the invention is advantageously used in photovoltaic cells, solar cells, flat or parabolic mirrors for concentrating solar energy, or else diffusers for backlighting display screens of LCD (liquid crystal display) type. It may also be used in flat lamps or screens based on organic light-emitting diodes.

In the case of applications in the photovoltaic field, and in order to maximize the energy efficiency of the cell, several improvements may be made, concurrently or alternately:

The glass sheet may advantageously be coated with at least one thin transparent and electro-conductive layer, for example based on SnO₂:F, SnO₂:Sb, ZnO:Al or ZnO:Ga. These layers may be deposited onto the substrate by various deposition processes, such as chemical vapour deposition (CVD) or deposition by sputtering, especially when enhanced by a magnetic field (magnetron sputtering process). In the CVD process, halide or organometallic precursors are vaporized and transported by a carrier gas to the surface of the hot glass, where they decompose under the effect of the heat to form the thin layer. The advantage of the CVD process is that it is possible to use it within the glass sheet forming process, especially when this is a float process. It is thus possible to deposit the layer at the moment when the glass sheet is on the tin bath, at the outlet of the tin bath, or else in the lehr, that is to say at the moment when the glass sheet is annealed in order to eliminate the mechanical stresses. The glass sheet coated with a transparent and electroconductive layer may be, in turn, coated with a semiconductor based on amorphous or polycrystalline silicon, on chalcopyrites (especially of the CIS—CuInSe₂ or CIGS—CuInGaSe₂ type) or on CdTe in order to form a photovoltaic cell. It may especially be a second thin layer based on amorphous silicon, CIS or CdTe. In this case, another advantage of the CVD process lies in obtaining a greater roughness, which generates a light-trapping phenomenon, which increases the amount of photons absorbed by the semiconductor.
The glass sheet may be coated on at least one of its faces with an antireflection coating. This coating may comprise one layer (for example based on porous silica with a low refractive index) or several layers. In the latter case a multilayer stack based on a dielectric material alternating layers with high and low refractive indices and ending with a layer with a low refractive index is preferred. It may especially be a multilayer stack described in application WO 01/94989 or WO 2007/077373. The antireflection coating may also comprise, as the last layer, a self-cleaning and anti-soiling layer based on photocatalytic titanium oxide, as taught in application WO 2005/110937. A low reflection may thus be obtained that is long-lasting. In applications in the photovoltaic field, the anti-reflection coating is deposited on the outer face, namely the face in contact with the atmosphere, while the optional transparent, electroconductive layer is deposited on the inner face, on the semiconductor side.
The surface of the glass sheet may be textured, for example have motifs (especially pyramid-shaped motifs), as described in Applications WO 03/046617, WO 2006/134300, WO 2006/134301 or else WO 2007/015017. These texturings are in general obtained using a rolling process for forming the glass.

The present invention will be better understood on reading the detailed description below of non-limiting exemplary embodiments.

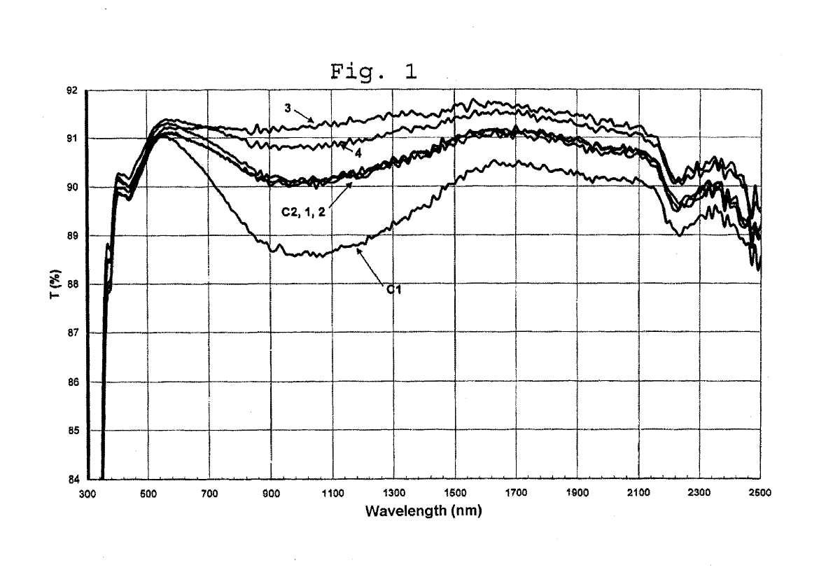

FIG. 1 represents the optical spectra in transmission obtained for the various examples.

### EXAMPLES

Two frits containing antimony were produced. Their composition (expressed as percentages by weight) is indicated in table 1 below. As indicated in the table, one portion of the sodium oxide (Na₂O) is added in nitrate form, the other portion in carbonate form. The two frits are obtained by melting for 2 hours at 1300° C. They are formed from grains which are a few millimeters in diameter, by milling.

TABLE 1

| Oxides | Frit A % | Frit B % |
|---|---|---|
| SiO₂ | 55 | 60 |
| Na₂O (nitrate) | 10 | 10 |
| Na₂O (carbonate) | 15 | 10 |
| CaO | 9 | 10 |
| Sb₂O₃ | 10 | 10 |
| Li₂O | 1 | 0 |

Each of the frits is used to obtain a glass, the composition of which is the following (expressed as percentages by weight):

| | |
|---|---|
| SiO₂ | 71.3 |
| Al₂O₃ | 0.55 |
| CaO | 9.5 |
| MgO | 4.0 |
| Na₂O | 13.85 |
| Fe₂O₃ | 0.03 |
| Sb₂O₃ | 0.50 |

Depending on the tests, the frit is added either to the batch mix (before the melting step), or after the melting step, at a temperature of 1300° C.

According to a comparative test C2, an equivalent amount of antimony is added to the batch mix in the form of antimony pentoxide.

In the case of the comparative example C1, there is no addition of antimony.

Table 2 below summarizes the redox values and the energy transmission values obtained, indicating in each case the frit used (A or B) and the method of introducing the frit, by addition to the batch mix (“batch” mode) or after melting (“feeder” mode).

The energy transmission, denoted TE, is calculated according to the ISO 9050: 2003 standard for a glass thickness of 3.2 mm.

TABLE 2

| | | Introduction | | |
|---|---|---|---|---|
| Test | Frit | Frit | Redox | TE (%) |
| C1 | — | — | 0.25 | 89.4 |
| C2 | — | — | 0.09 | 90.1 |
| 1 | A | Batch | 0.09 | 90.1 |
| 2 | B | Batch | 0.09 | 90.3 |
| 3 | A | Feeder | 0.02 | 90.6 |
| 4 | B | Feeder | 0.05 | 90.6 |

The addition of antimony oxide in the form of a frit to the batch mix makes it possible to reduce the redox, to a similar extent to the addition of antimony pentoxide.

On the other hand, the addition of the frit after the melting step is more effective in terms of reducing the redox, and makes it possible to attain glass sheets for which the light and energy transmission is much higher.

The effect of oxidation can also be seen in the optical spectra of FIG. 1, where the reduction in the absorption band due to the ferrous iron (centered at around 1000 nm) can be seen.

The frit A makes it possible to achieve better results than the frit B, probably due to a greater fluidity.

1. A process for obtaining a glass sheet comprising antimony oxide, said process comprising melting a batch mix to produce a molten glass, transporting the molten glass to at least one forming device, and forming the glass sheet, wherein a glass frit comprising a weight content of antimony oxide between 2 and 30% is added, concurrently or alternately, to said batch mix, during said melting, or during said transporting of the molten glass to the at least one forming device.

2. The process as claimed in claim 1, wherein the weight content of antimony oxide of the glass frit is between 8 and 15%.

3. The process as claimed in claim 1, wherein, in the glass frit, the proportion of pentavalent antimony (Sb⁵⁺) relative to all of the antimony is greater than or equal to 20%.

4. The process as claimed in claim 1, wherein the glass frit has a temperature at which the viscosity of the glass is 100 poise of between 850 and 1150° C.

5. The process as claimed in claim 1, wherein the glass frit has a viscosity at a temperature of 1050° C. of between 30 and 300 poise.

6. The process as claimed in claim 1, wherein the glass frit comprises the following constituents in contents varying within the weight limits defined below:

| | |
|---|---|
| SiO₂ | 45 to 65% |
| Al₂O₃ | 0 to 10% |
| B₂O₃ | 0 to 5% |
| CaO | 5 to 20% |
| MgO | 0 to 10% |
| Na₂O | 5 to 20% |
| K₂O | 0 to 10% |
| BaO | 0 to 5% |
| Li₂O | 0 to 5% |
| Sb₂O₃ | 5 to 30%. |

7. The process as claimed in claim 1, wherein the glass frit is in the form of fragments, a maximum dimension of which does not exceed 10 mm.

8. The process as claimed in claim 1, wherein the glass frit is only added during the transporting of the molten glass to the at least one forming device.

9. The process as claimed in claim 1, wherein the forming is carried out by rolling between several rolls.

10. The process as claimed in claim 1, wherein the glass sheet has a composition of soda-lime-silica type comprising a weight content of iron oxide, expressed as Fe₂O₃, of between 0.003% and 0.05%.

11. The process as claimed in claim 1, wherein the redox of the glass sheet is less than or equal to 0.1.

12. The process as claimed in claim 1, wherein the light transmission of the glass sheet within the meaning of the ISO 9050: 2003 standard is greater than or equal to 90% for a thickness of 3.2 mm.

13. A glass sheet capable of being obtained by the process as claimed in claim 1.

14. A method comprising utilizing the glass sheet as claimed in claim 13 in photovoltaic cells, solar cells, flat or parabolic mirrors for concentrating solar energy, or else diffusers for backlighting display screens of the LCD (liquid crystal display) type.

15. The process as claimed in claim 6, wherein the content of B₂O₃ is 0% and the content of BaO is 0%.

16. The process as claimed in claim 7, wherein the maximum dimension does not exceed 2 mm.

17. The process as claimed in claim 10, wherein the weight content of iron oxide, expressed as Fe₂O₃, is between 0.007% and 0.02%.

18. The process as claimed in claim 11, wherein the redox of the glass sheet is less than or equal to 0.05.

19. The process as claimed in claim 18, wherein the redox of the glass sheet is zero.

20. The process as claimed in claim 12, wherein the light transmission of the glass sheet within the meaning of the ISO 9050: 2003 standard is greater than or equal to 91% for a thickness of 3.2 mm.
